(19) United States
(12) Patent Application Publication
(10) Pub. No.: US 2007/0286797 A1
(43) Pub. Date: Dec. 13, 2007

(54) Process and device for producing hydrogen from organic oxygen compounds

(76) Inventors: Axel Behrens, Munchen (DE); Peter Bender, Munchen (DE); Nicole Schodel, Munchen (DE); Hubertus Winkler, Grainau (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/785,056

(22) Filed: Apr. 13, 2007

(30) Foreign Application Priority Data
Apr. 13, 2006 (DE) 10 2006 017 888.2

(51) Int. Cl. C01B 6/24; C01B 3/02; B01D 50/00

(52) U.S. Cl. 423/644; 423/648.1; 422/170

(57) ABSTRACT

At least one hydrogen-containing product stream (4) can be obtained from feedstocks (1) that contain organic oxygen compounds with more than one carbon atom. In the process, an intermediate product is obtained from the feedstock (1) in a first process step in a first reactor (P). The intermediate product is then reacted by steam reforming in a steam-reforming reactor (steam reformer) (D), which is heated from the outside, to obtain a synthesis gas (3) that contains hydrogen and carbon monoxide.

The invention relates to a process for producing at least one hydrogen-containing product stream that consists of feedstocks that contain organic oxygen compounds with more than one carbon atom, as well as a device for performing the process.

In an attempt to reduce the input of carbon dioxide into the earth's atmosphere or to at least not let it increase further, and as an alternative to the disappearing petroleum and natural gas reserves, energy sources in the future will be increasingly produced from renewable raw materials. According to an EU guideline, at least 5.75% of the fuel requirement in the European Union is to be covered by such energy sources until 2010. In this connection, bio-diesel, which is already now added at a concentration of up to five percent to the diesel fuel that is available at German gas stations, plays a tremendous role.

Bio-diesel is a standardized fuel that is obtained primarily from rapeseed oil but also from other vegetable oils and fats. Vegetable oils and fats consist of triglycerides, i.e., fatty acids, which in each case are bonded three at a time to glycerol. As a result, vegetable oils and fats at normal ambient temperatures are viscous to solid, i.e., they have a much higher viscosity than the fuels for which a commercially available diesel engine is designed. Vegetable oils and fats behave differently in the injection process, and also the combustion of vegetable oils and fats proceeds less cleanly. These drawbacks can only be partially compensated for by making modification to the motor—such as by providing means for preheating the vegetable oil.

Bio-diesel is produced from vegetable oils and fats by the replacement of glycerol by methanol. Its viscosity corresponds to that of commercially available diesel fuel, and thus it can also be easily combusted in unmodified diesel engines.

In bio-diesel production, considerable amounts of glycerol accumulate in the form of crude glycerol. The crude glycerol has a glycerol content of 80-85%, but in addition also contains water and salts in larger amounts, as well as residual substances from the production process. According to the prior art, the crude glycerol is purified by vacuum distillation, deodorization and filtration, to the extent that it satisfies the strict requirements of the European Pharmacopoeia, and it can be purchased with a purity of at least 99.5% as a pharmaglycerol in the pharmaceutical industry. Currently, the total amount of glycerol that accumulates in the production of bio-diesel can be used in this way. With the foreseeable expansion of the bio-diesel production, this will become increasingly more difficult in the future, however, such that still other methods must be sought for the exploitation of the glycerol byproduct obtained from bio-diesel production.

### SUMMARY OF INVENTION

Thus, in accordance with the invention there is provided a process (and apparatus) that can economically convert a feedstock comprising organic oxygen compounds, such as the glycerol that accumulates in the bio-diesel production.

Upon further study of the specification and appended claims, further objects, aspects and advantages of this invention will become apparent to those skilled in the art.

According to a process embodiment of the invention, the feedstock is converted in a first process step in a first reaction zone to obtain an intermediate product. The intermediate product is then subjected to steam reforming in a steam-reforming reactor (steam reformer), which is heated from the outside, i.e., by an external source as opposed to an autothermal steam reformer, to form a synthesis gas containing hydrogen and carbon monoxide.

Additional embodiments, features and aspects of the process according to the invention include the following:
In the first process step, steam is fed to the first reaction zone (e.g., a first reactor), and the feedstock(s) are reacted in the presence of steam.
In the first process step, the feedstocks are reacted in the convection zone of the steam reformer.

Therein, heat is transferred, predominantly by convection, from a heating source (e.g., a burner) to the reactor in which the steam reforming takes place (e.g., in a tube filled with catalyst).
The first process step is pyrolysis reaction performed in a pyrolysis reactor.
The first process step is a partial oxidation reaction (POX) performed in a POX reactor, in which a suitable oxidizing agent is fed to the POX reactor. Air, oxygen-enriched air, and oxygen are preferred oxidizing agents.
Steam is added to the intermediate product from the first process step before entry into the steam reformer.
A suitable oxidizing agent is added during steam reforming. Preferably, the oxidizing agent is air, oxygen-enriched air, or oxygen.
The steam reforming is performed in the presence of a catalyst.
The catalysts that are used in the catalytic steam reforming process comprise nickel (Ni), platinum (Pt), palladium (Pd), iron (Fe), rhodium (Rh), ruthenium (Ru), iridium (Ir), or combinations thereof. For example, the catalyst can comprise (or consist of) Ni and/or Pt and/or Pd and/or Fe and/or Rh and/or Ru and/or Ir.
In the catalytic steam reforming, the catalysts that are used are also suitable catalysts for catalytic steam reforming of naphtha or methane.
A product gas with a defined hydrogen/carbon monoxide ratio is produced from the synthesis gas by a water gas-shift reaction. According to one embodiment of the inventive process, the water gas-shift reaction is performed within the steam reformer. According to another embodiment of the inventive process, the water gas-shift reaction is performed in a water gas-shift reactor (shift reactor) downstream to the steam reformer. In this case, a water gas-shift reaction can be defined as an equilibrium reaction, in which carbon monoxide is reacted with water to form carbon dioxide and hydrogen.
The feedstock(s) contain alcohols with more than one alcohol group, in particular glycerol.
The feedstocks are obtained from biogenic raw materials, for example, a glycerol-containing feedstock obtained from the production of bio-diesel.

According to an apparatus aspect of the invention, the invention provides an apparatus suitable for producing at least one product stream that contains hydrogen from feedstocks that contain organic oxygen compounds with more than one carbon atom.

According to another apparatus embodiment of the invention, there is provided an apparatus comprising: a first reactor, in which an intermediate product can be produced from a feedstock, and, downstream therefrom, a steam-reforming reactor (steam reformer), which is heated from the outside, in which the intermediate product, produced in the first reactor, is converted into a synthesis gas that contains hydrogen and carbon monoxide.

According to another apparatus embodiment of the invention, there is provided an apparatus for producing at least one hydrogen-containing product stream from at least one feedstock containing organic oxygen compounds with more than one carbon atom, the apparatus comprising:

a first reactor having an inlet for introducing a feedstock containing organic oxygen compounds with more than one carbon atom, and an outlet for discharging an intermediate product, and

a steam-reforming reactor, that can be heated from the outside, having an inlet in fluid communication with the outlet of the first reactor and an outlet for discharging a synthesis gas containing hydrogen and carbon monoxide, wherein intermediate product from the first reactor can be reacted in said steam-reforming reactor to produce the synthesis gas containing hydrogen and carbon monoxide.

Additional embodiments, features and aspects of the apparatus according to the invention include the following:
The first reactor is arranged in the convection zone of the steam reformer.
The first reactor is a reactor for performing pyrolysis (pyrolysis reactor) or a reactor for performing partial oxidation (POX reactor).
The steam reformer is a steam-reforming reactor for performing catalytic steam reforming.
At least a portion of the synthesis gas containing hydrogen and carbon monoxide is introduced into a reactor for performing a water gas-shift reaction (shift reactor), from which a product gas with a defined hydrogen/carbon monoxide ratio can be produced. According to one embodiment of the apparatus according to the invention, water gas-shift reactor is positioned downstream of the steam reformer. According to one embodiment of the apparatus according to the invention, water gas-shift reaction is performed within the steam reformer.

The invention is suitable for producing hydrogen and/or synthesis gas from a wide variety of feedstocks. The pyrolysis of the feedstocks allows the use of a steam reformer that is simply built and that is economical to operate, with a catalytic bed that is designed as a solid bed. As a result of the non-catalytic reactor upstream from the steam reformer reactor, problems with carbon deposits on the steam-reforming catalyst can be avoided.

### BRIEF DESCRIPTION OF THE DRAWINGS

Various other features and attendant advantages of the present invention will be more fully appreciated as the same becomes better understood when considered in conjunction with the accompanying drawing wherein:

FIG. 1 is a flow chart for an embodiment of the invention involving a pyrolysis reaction, steam reforming, and a shift reaction.

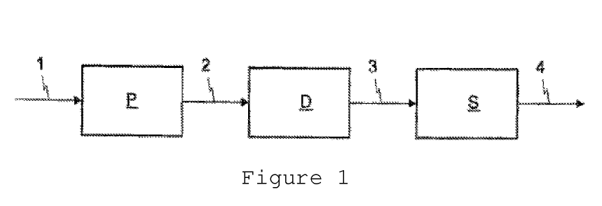

The embodiment shown in FIG. 1 relates to a unit for the production of a product gas that contains mainly hydrogen, wherein crude glycerol from the bio-diesel production from is used as the feedstock. The glycerol feedstock contains up to about 85% glycerol, (preferably about 80-85%) but in addition also contains water and salts as well as residual substances from the production process in considerable amounts, e.g., up to about 20%.

Via line 1, the crude glycerol feedstock is introduced into the pyrolysis reactor P and reacted there to form a pyrolysis product. The pyrolysis product is drawn off via line 2 from the pyrolysis reactor P and further directed into the steam reformer D, where it is reacted in the presence of a catalyst to form a synthesis gas that contains predominantly hydrogen and carbon monoxide. The pyrolysis reactor preferably has no catalyst and is operated at a pressure, preferably, in the range of 10-50 bar and at a temperature, preferably, in the range of 350-950° C., more preferably 500-800° C. The construction of the reactor is not limited but, for example, can provide feedstock passed through a tube coil in the convection zone of the steam reformer or in a separate heating jacket. The steam reformer, D, is preferably operated at a pressure range of 10-50 bar, an inlet temperature range of 500-700° C. and an outlet temperature range of 700-1000° C. Via line 3, synthesis gas containing predominantly hydrogen and carbon monoxide is removed from the steam reformer D and fed to the shift reactor S. The shift reactor is preferably a shell and tube reactor. The shift reactor is preferably operated at a pressure range of 10-50 bar, an inlet temperature range of 200-400° C. and an outlet temperature range of 250-450° C. The shift reactor contains a conventional shift catalyst. From the shift reactor S, in which the predominant portion of the carbon monoxide is reacted with water to form carbon dioxide and hydrogen, a product gas that contains predominantly hydrogen is drawn off via line 4 and sent out for further treatment (not shown).

The entire disclosures of all applications, patents and publications, cited herein and of corresponding German application No. DE 10200601788.2, filed Apr. 13, 2006, are incorporated by reference herein.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

1. A process for producing at least one hydrogen-containing product stream from at least one feedstock containing organic oxygen compounds with more than one carbon atom, said process comprising:
introducing a feedstock containing organic oxygen compounds with more than one carbon atom into a first reaction zone to produce an intermediate product,
subjecting said intermediate product steam reforming in a steam-reforming reactor, which can be heated from the outside, to obtain a synthesis gas containing hydrogen and carbon monoxide.

2. A process according to claim 1, wherein steam is fed into said first reaction zone, whereby said feedstock is reacted in the presence of steam.

3. A process according to claim 1, wherein said first reaction zone is in the convection zone of said steam reformer.

4. A process according to claim 1, wherein a pyrolysis reaction is performed in said first reaction zone, and said pyrolysis reaction is performed in a pyrolysis reactor.

5. A process according to claim 1, wherein a partial oxidation reaction is performed in said first reaction zone, and said partial oxidation reaction is performed in a partial oxidation reactor into which an oxidizing agent is fed.

6. A process according to claim 1, wherein steam is added to the intermediate product obtained from the first reaction zone before entry into the steam reformer.

7. A process according to claim 1, wherein an oxidizing agent is introduced into said steam reformer whereby the steam reforming is performed in the presence of said oxidizing agent.

8. A process according to claim 1, wherein the steam reforming is performed in the presence of a catalyst.

9. A process according to claim 8, wherein said catalyst comprises nickel (Ni), platinum (Pt), palladium (Pd), iron (Fe), rhodium (Rh), ruthenium (Ru), iridium (Ir) or combinations thereof.

10. A process according to claim 8, wherein the catalyst used in the steam reforming is also suitable for use in catalytic steam reforming of naphtha or methane.

11. A process according to claim 1, further comprising producing a product gas with a defined hydrogen/carbon monoxide ratio from said synthesis gas by water gas-shift reaction.

12. A process according to claim 11, wherein said water gas-shift reaction is performed within said steam reformer.

13. A process according to claim 11, wherein said water gas-shift reaction is performed in a water gas-shift reactor is downstream of said steam reformer.

14. A process according to claim 1, wherein said feedstock contains one or more alcohols with more than one alcohol group.

15. A process according to claim 14, wherein said feedstock contains glycerol.

16. A process according to claim 1, wherein said feedstock is obtained from biogenic raw materials.

17. An apparatus for producing at least one hydrogen-containing product stream from at least one feedstock containing organic oxygen compounds with more than one carbon atom, said apparatus comprising:
a first reactor having an inlet for introducing a feedstock containing organic oxygen compounds with more than one carbon atom, and an outlet for discharging an intermediate product, and
a steam-reforming reactor, that can be heated from the outside, having an inlet in fluid communication with said outlet of said first reactor and an outlet for discharging a synthesis gas containing hydrogen and carbon monoxide, wherein intermediate product from said first reactor can be reacted in said steam-reforming reactor to produce said synthesis gas containing hydrogen and carbon monoxide.

18. An apparatus according to claim 17, wherein said first reactor is positioned within a convection zone of the steam reformer.

19. An apparatus according to claim 17, wherein said first reactor is a pyrolysis reactor.

20. An apparatus according to claim 17, wherein the first reactor is a reactor partial oxidation reactor.

21. An apparatus according claim 17, wherein said steam reformer is a catalytic steam reformer.

22. An apparatus according to claim 17, further comprising a water gas-shift reactor for producing from the synthesis gas a product gas with a defined hydrogen/carbon monoxide ratio, said water gas-shift reactor having an inlet in fluid communication with said outlet of said steam reformer and an outlet for discharging said product gas with a defined hydrogen/carbon monoxide ratio, wherein said water gas-shift reactor is positioned downstream of said stream reformer or is positioned within said steam reformer.
